(19) United States
(12) Patent Application Publication
(10) Pub. No.: US 2015/0220872 A1
(43) Pub. Date: Aug. 6, 2015

(54) METHOD AND AN APPARATUS FOR WORK PACKET QUEUING, SCHEDULING, AND ORDERING WITH CONFLICT QUEUING

(71) Applicant: Cavium, Inc., San Jose, CA (US)

(72) Inventors: Wilson Parkhurst Snyder, II, Holliston, MA (US); Richard Eugene Kessler, Northboroug, MA (US); Daniel Edward Dever, North Brookfield, MA (US); David Kravitz, Cambridge, MA (US)

(73) Assignee: CAVIUM, INC., San Jose, CA (US)

(21) Appl. No.: 14/170,955

(22) Filed: Feb. 3, 2014

(51) Int. Cl. G06Q 10/06

(52) U.S. Cl. CPC G06Q 10/063114

(57) ABSTRACT

A method and a system embodying the method for processing conflicting work, comprising: receiving a work request, the work request indicating one or more groups from a plurality of groups; finding work by arbitrating among a plurality of queues of the one or more groups; determining whether the found work conflicts with another work; returning the found work when the determination is negative; and adding the found work into a tag-chain when the determination is affirmative is disclosed.

### BACKGROUND

1. Field

The present disclosure relates to packet queuing, ordering, and scheduling with conflict queuing in a network processor. More particularly, the invention is directed to processing conflicting work in the network processor.

2. Description of Related Technology

A network processor is specialized processor, often implemented in a form of an integrated circuit, with a feature set specifically designed for processing packet data received or transferred over a network. Such packet data is transferred using a protocol designed, e.g., in accordance with an Open System Interconnection (OSI) reference model. The OSI defines seven network protocol layers (L1-7). The physical layer (L1) represents the actual interface, electrical and physical that connects a device to a transmission medium. The data link layer (L2) performs data framing. The network layer (L3) formats the data into packets. The transport layer (L4) handles end to end transport. The session layer (L5) manages communications between devices, for example, whether communication is half-duplex or full-duplex. The presentation layer (L6) manages data formatting and presentation, for example, syntax, control codes, special graphics and character sets. The application layer (L7) permits communication between users, e.g., by file transfer, electronic mail, and other communication known to a person of ordinary skills in the art.

The network processor may schedule and queue work (packet processing operations) for upper level network protocols, for example L4-L7, and being specialized for computing intensive tasks, e.g., computing a checksum over an entire payload in the packet, managing TCP segment buffers, and maintain multiple timers at all times on a per connection basis, allows processing of upper level network protocols in received packets to be performed to forward packets at wire-speed. Wire-speed is the rate of data transfer of the network over which data is transmitted and received. By processing the protocols to forward the packets at wire-speed, the network services processor does not slow down the network data transfer rate. An example of such processor may be found in U.S. Pat. No. 7,895,431.

To improve network processor efficiency, multiple processor cores are scheduled to carry the processing via a scheduling module. The scheduling module divides the work to be scheduled into a plurality, e.g., eight, Quality-of-Service (QoS)-organized lists of work. Upon a request for work from a processor core the QoS-organized lists are searched to find a list a work of which is of the highest priority and the list is enabled to be scheduled to the specified processor core. The found work must also not conflict with any other work being already processed. When the found work conflicts, the found work is skipped until the processing of the conflicting work finishes. The same found work may be skipped many times, reducing performance.

Although the method and the apparatus embodying the method, presented in a U.S. application Ser No. 13/285,773, filed on Oct. 31, 2011, by Kravitz, David, et al., entitled WORK REQUEST PROCESSOR, avoided some of the searches; method was not successful in completely eliminating occasional skipping of the same work many times.

Accordingly, there is a need in the art for method and an apparatus, providing a solution to the above identified problems, as well as additional advantages.

### SUMMARY

In an aspect of the disclosure, a method and an apparatus implementing the method for processing conflicting work according to appended independent claims is disclosed. Additional aspects are disclosed in the dependent claims.

### BRIEF DESCRIPTION OF THE DRAWINGS

The foregoing aspects described herein will become more readily apparent by reference to the following description when taken in conjunction with the accompanying drawings wherein:

FIG. 1 depicts a conceptual structure of a network processor in accordance with an aspect of this disclosure;

FIG. 2a depicts a first part of a flow chart for packet queuing, ordering, and scheduling with conflicting queuing in the network processor in accordance with an aspect of this disclosure; and

FIG. 2b depicts a second part of the flow chart for packet queuing, ordering, and scheduling with conflicting queuing in the network processor in accordance with the aspect of this disclosure;

FIG. 3 depicts a flow chart enabling a process of de-scheduling work in accordance with an aspect of this disclosure; and

FIG. 4 depicts a flow chart enabling a process of removal of work from a work-slot in the network processor in accordance with an aspect of this disclosure.

An expression “_X” in a reference indicates an instance of an element of a drawing where helpful for better understanding. Any unreferenced arrow or double-arrow line indicates a possible information flow between the depicted entities.

### DETAILED DESCRIPTION

Unless otherwise defined, all terms (including technical and scientific terms) used herein have the same meaning as commonly understood by a person having ordinary skill in the art to which this invention belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

Various disclosed aspects may be illustrated with reference to one or more exemplary configurations. As used herein, the term “exemplary” means “serving as an example, instance, or illustration,” and should not necessarily be construed as preferred or advantageous over other configurations disclosed herein.

Various aspects of the present invention will be described herein with reference to drawings that are schematic illustrations of conceptual configurations of the present invention, unless explicitly noted. The various aspects of this disclosure are provided to enable a person having ordinary skill in the art to practice the present invention. Modifications to various aspects of a presented throughout this disclosure will be readily apparent to a person having ordinary skill in the art, and the concepts disclosed herein may be extended to other applications.

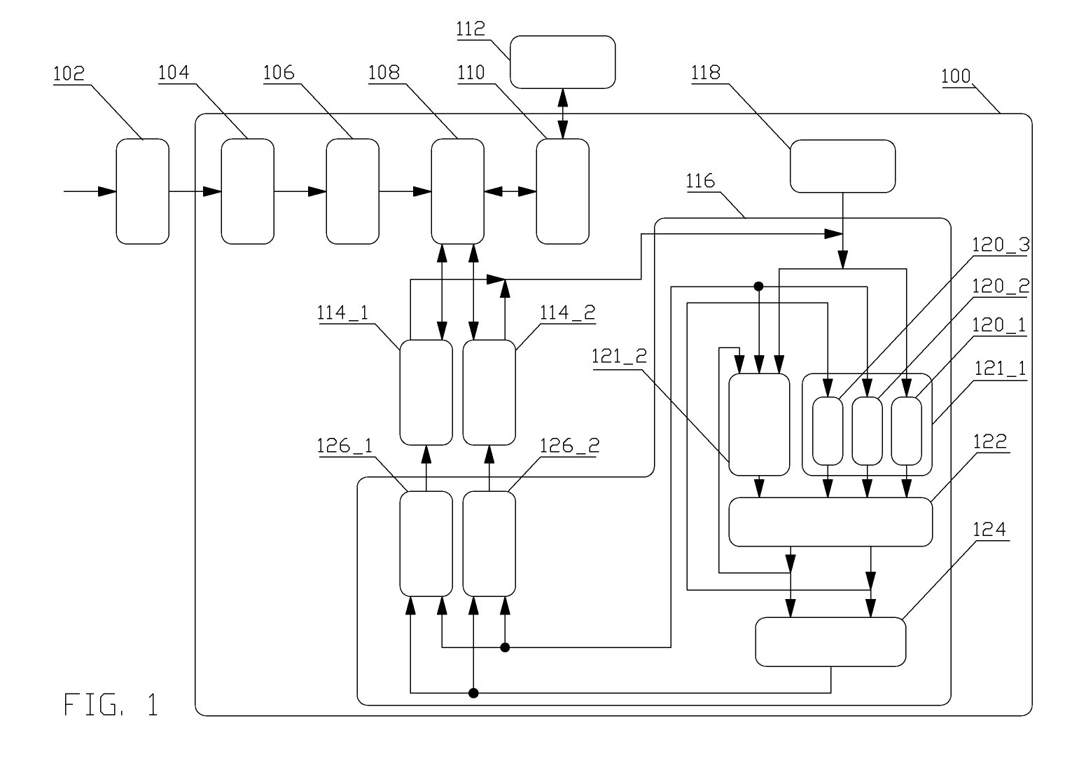

FIG. 1 depicts a conceptual structure of a network processor 100. A packet is received over a network (not shown) at a physical interface unit 102. The physical interface unit 102 provides the packet to a network processor interface 104.

The network processor interface 104 carries out L2 network protocol pre-processing of the received packet by checking various fields in the L2 network protocol header included in the received packet. After the network processor interface 104 has performed L2 network protocol processing, the packet is forwarded to a packet input unit 106.

The packet input unit 106 performs pre-processing of L3 and L4 network protocol headers included in the received packet, e.g., checksum checks for Transmission Control Protocol (TCP)/User Datagram Protocol (UDP). The packet input unit 106 writes packet data into a level L2 cache 108 and/or a memory 112. A cache is a component, implemented as a block of memory for temporary storage of data likely to be used again, so that future requests for that data can be served faster. If requested data is contained in the cache (cache hit), this request can be served by simply reading the cache, which is comparatively faster. Otherwise (cache miss), the data has to be recomputed or fetched from its original storage location, which is comparatively slower. The memory 112 may comprise any physical device(s) used to store instructions and/or data on a temporary or permanent basis. Any type of memory known to a person skilled in the art is contemplated. In an aspect, the memory 112 is external to the network processor 100 and is accessed via a memory controller 110. The packet input unit 106 supports a programmable buffer size and can distribute packet data across multiple buffers to support large packet sizes.

Any additional work, i.e., another operation of additional packet processing, required on the packet data is carried out by a software entity executing on one or more processor cores 114. Although only two processor cores 114_1, 114_2 are shown, a person of ordinary skills in the art will understand that other number, including a single core is contemplated. Each of the one or more processor cores 114 is communicatively coupled to the L2 cache 108.

Work is scheduled by a Schedule, Synchronize, and Order (SSO) unit 116. Generally, work is a software routine or handler to be performed on some data. With regards to the SSO unit 116, work is a pointer to memory, where that memory contains a specific layout. In an aspect, the memory comprises the cache 108 and/or the memory 112. In an aspect, the layout comprises a work-queue entry storing the data and/or the instructions to be processed by the software entity execution on one or more of the processor cores 114, initially created by the packet input unit 106 or the software entity executing on each processor core 114. In an aspect, the work-queue entry may further comprise metadata for the work. In another aspect, the metadata may be stored in work queues 120. In an aspect, the metadata may comprise a group-indicator, a tag, and a tag-type.

A person skilled in the art will appreciate that the SSO unit 116 comprises additional hardware units in addition to the hardware units explicitly depicted and described in FIG. 1 and associated text. Thus, reference to a step or an action carried out by the SSO unit 116 is carried out by one of such additional hardware units depending on a specific implementation of the SSO unit 116.

Each group 121 comprises a collection of one of more work queues 120. Although only one group 121 is depicted, a person of ordinary skills in the art will understand that other number of groups is contemplated. Because the organization of queues within a group and information flow among the queues and other elements of the network processor 100 is identical among the groups 121, to avoid necessary complexity the organization and information flow is shown in detail only for a group 121_1. Each group 121 is associated with at least one processor core 114. Consequently, when a software entity executing on the processor core 114 or the processor core 114 itself requests work, the arbitration does not need to be made for the groups 121 not associated with the processor core 114, improving performance. Although both the software entity and the processor core may be the requestor, in order to avoid unnecessary repetitiveness, in the reminder of the disclosure only the software entity is recited.

Each of the one of more work queues 120 may comprise at least one entry comprising work, and, optionally, also a tag, and a tag-type to enable scheduling of work to one or more processor cores 114; thus allowing different work to be performed on different processor cores 114. By means of an example, packet processing can be pipelined from one processor core to another, by defining the groups from which a processor core will accept work.

A tag is used by the SSO unit 116 to order and synchronize the scheduled work, according to the tag and a tag-type selected by the processor core 114. The tag allows work for the same flow (from a source to a destination) to be ordered and synchronized. The tag-type selects how the work is synchronized and ordered. There are three different tag-types. Ordered, i.e., work ordering is guaranteed, however, atomicity is not. Such a tag-type may be used during a de-fragmentation phase of packet processing, so that fragments for the same packet flow are ordered. Atomic i.e., work ordering and atomicity are guaranteed, in other words, when two work items have the same tag, the work must be processed in order, with the earlier work finishing before the later work can begin. Such a tag-type may be used for IPSec processing to provide synchronization between packets that use the same IPSec tunnel. Thus, IPSec decryption is carried out with atomic tag-type. Untagged, i.e., work ordering among the processor cores is not guaranteed, and the tag is not relevant with this tag-type. Such a tag may be used for processing different packet flows, which will likely have different tag, so will likely not be ordered and synchronized relative to each other, and can be executed completely in parallel on different processor cores 114.

Work queue entry may be created by hardware units, e.g., the packet input unit 106, in the memory 112. The add work request may then be submitted to the SSO unit 116 via an add-work entity 118. Alternatively, work queue entry may be created and add work request may be submitted by a software entity running at a processor core 114. In an aspect, work queue entry is created and add work request is submitted via the add-work entity 118 upon each packet arrival. In other aspects, work queue entry may be created upon completion of sending a packet, completion of compressing/decompressing data from a packet, and/or other events known to person of ordinary skills in the art.

Upon receiving the add work request, the SSO unit 116 adds the work, the tag, and the tag-type associated with the work, into an admission queue 120_1 corresponding to the group 121, indicated by the add work request. In an aspect, the admission queue 120_1 may overflow to the cache 108 and/or the storage 112. In addition to the admission queue 120_1, the group 121 may further comprise other queues, e.g., a de-scheduled queue 120_2 and a conflicted queue 120_3.

Regarding the de-scheduled queue 120_2, a software entity executing on a processor core can de-schedule scheduled work, i.e., work provided by the SSO unit to the processor core associated work-slot, that the processor core cannot complete. De-schedule may be useful in a number of circumstances, e.g., the software entity executing on a processor core can de-schedule scheduled work in order to transfer work from one group to another group, to avoid consuming a processor core for work that requires a long synchronization delay, to process another work, to carry out non-work related processing, or to look for additional work. Such non-work related processing comprises any processing not handled via the SSO unit. By means of an example, such processes may comprise user processes, kernel processes, or other processes known to a person of ordinary skills in the art. The de-scheduled work is placed into the de-scheduled queue 120_2 to be re-scheduled by the SSO unit at a later time.

To understand the role of the conflicted queue 120_3, consider that a work provided by the SSO unit 116 to, e.g., the work-slot 126_1, in response to the processor core 114_1 request for work, comprises work tag that matches a tag in any of the work-slot 126, e.g., the work-slot 1262 and the tag-type is atomic. In that case, the work cannot be immediately scheduled and is first moved to a tag-chain and, eventually, to a conflicted queue 120_3.

The tag-chain is a linked-list structure for each tag value, stored in a memory. Any type of memory known to a person skilled in the art is contemplated. In an aspect, the memory comprises a Content Addressable Memory (CAM). The memory is part of a tag-chain manager interfacing the memory with other elements of the network processor 100. The tag-chain manager 124 thus assists the SSO unit 116, to account for work that cannot be processed in parallel due to ordered or atomic requirements. By consulting the tag-chain manager 124, the SSO unit 116 may ascertain what work each processor core 114 is acting upon, and the order of work for each corresponding tag value.

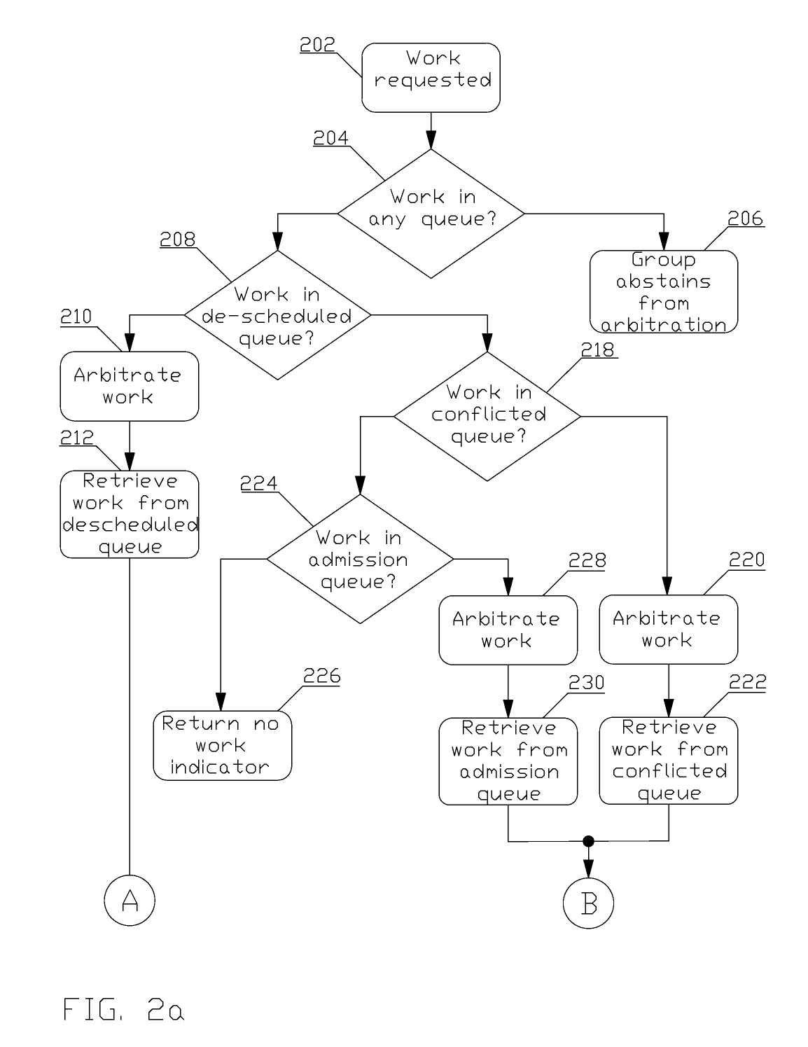

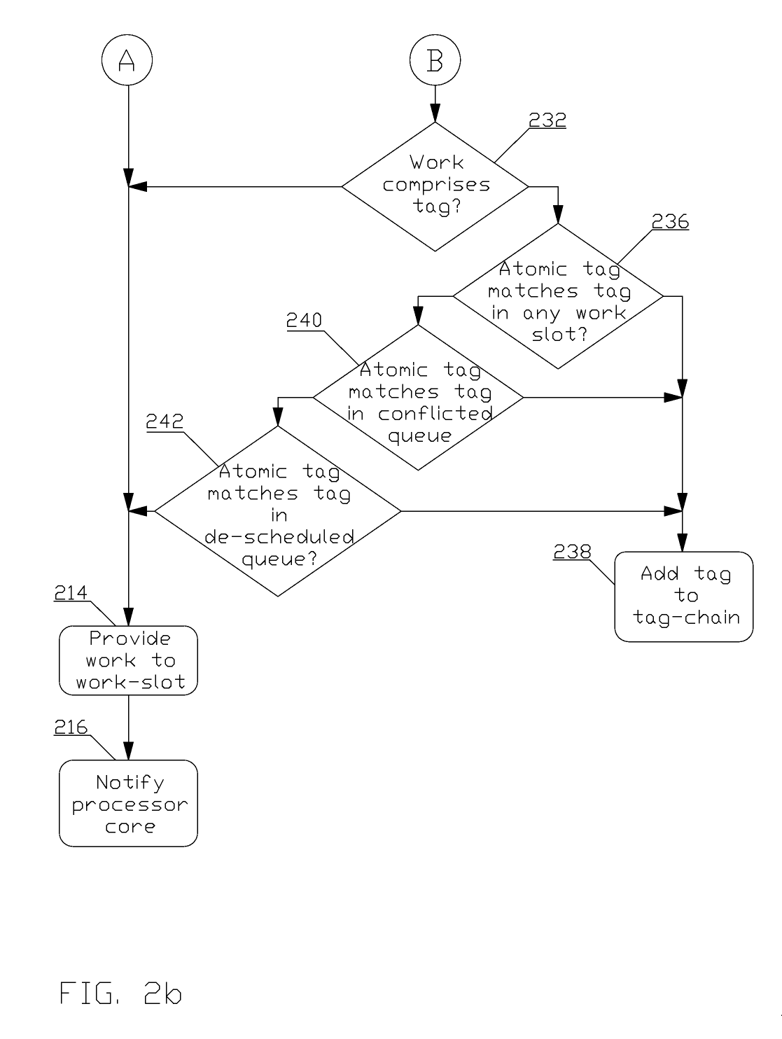

Based on the foregoing, every time the software entity executing on processor core 114 request work, since all the work queues 120 may comprise work, the work queues 120 have to be considered by the SSO unit 116. Such a process is disclosed in FIG. 2. To clarify the relationship between certain elements of a conceptual structure and information flow among the elements of the structure enabling the process for packet queuing, ordering, and scheduling with conflicting queuing in the network processor depicted in FIG. 1 in the FIG. 2 description, the references to structural elements of FIG. 1 are in parenthesis.

In step 202, a software entity executing on one of the processor cores (114) is ready to obtain work to process. The software entity executing on, e.g., processor core (114_1) issues a GET WORK requesting work from the SSO unit (116) via the associated work-slot (126_1). As disclosed supra, the work request indicates one or more groups associated with the processor core (114_1); consequently, only those groups need to be arbitrated among. In an aspect, the GET_WORK request is initiated by a load instruction to an input/output (I/O) address. In another aspect, the GET_WORK request is initiated by a store instruction and returned into a memory location specified by the processor core (114_1). The process continues in step 204.

In step 204, in response to the request, a get-work arbiter (122) determines whether any of the groups (121) have work in any of the work queues (120) and may thus bid, i.e., be eligible to participate in the arbitration process. The arbitration process results in selecting work from one of the groups (121) that will be provided to the work-slot (126_1). The work-slot (126_1) notifies software entity executing on the requesting processor core (114_1) that work is available. In an aspect, the notification is the return of processor requested I/O read data. The processing of the groups (121) that do not have work in at least one of the work queues (120) continues in step 206; the processing of the other groups (121) continues in step 208.

In step 206 the groups (121) that do not have work in one of the work queues (120) abstain from the arbitration process until a new arbitration process starts in step 202.

In step 208, the get-work arbiter (122) first determines whether any of the bidding groups (121) have work in a de-scheduled queue (120_2). As described supra, a processor core may de-schedule work. Work in the de-scheduled queue (120_2) has the highest priority because the work has already passed through the admission queue (120_1) and, possibly, through the conflicted queue (120_3) as disclosed infra. When the determination is affirmative, i.e., work is found in at least one de-scheduled queue (120_2), the process continues in step 210; otherwise, the process continues in step 218.

In step 210, the get-work arbiter (122) arbitrates among only the de-scheduled queues (1202) of the bidding groups (121) to select one group (121), from which work will be provided to the work-slot (126_1) and, eventually, to the software entity executing the processor core (114_1). A person of ordinary skills in the art will understand that any arbitration employed by the arbiter (122) known in the art may be used, e.g., a round-robin process. A novel arbitration that may be employed by the arbiter (122) is disclosed in a co-pending application no. ______/______,______, filed on Feb. 3, 2014, by Wilson P. Snyder II, et al., entitled A METHOD AND AN APPARATUS FOR WORK REQUEST ARBITRATION IN A NETWORK PROCESSOR. The process continues in step 212.

In step 212, the get-work arbiter (122) retrieves work from the de-scheduled queue (120_2) from the group (121) selected by the arbitration process. The process continues in step 214.

In step 214, the get-work arbiter (122) provides the retrieved work to a work-slot (126_1). Additionally, when the retrieved work has an atomic tag-type, the work is also provided to the tag-chain manager (124) to add the work to a tag-chain corresponding to the tag value when such a tag-chain exists, or establish a new tag-chain when tag-chain corresponding to the tag value does not exist. The process continues in step 216.

In step 216, work-slot (126_1) notifies software entity executing on the processor core (114_1) that work is available. The process is concluded until a new process starts in step 202.

In step 218, when no work has been found in any of the de-scheduled queues (120_2) of the bidding groups (121), the get-work arbiter (122) next determines whether any of the bidding groups (121) has work in a conflicted queue (120_3). When the determination is affirmative, i.e., work is found in at least one conflicted queue (120_3), the process continues in step 220; otherwise, the process continues in step 224.

In step 220, the get-work arbiter (122) arbitrates among only the conflicted queues (120_3) of the bidding groups (121) to select one group (121), from which work will be provided to the work-slot (126_1) and, eventually, to the software entity executing on the processor core 114_1. The process continues in step 222.

In step 222, the SSO unit (116) retrieves work from the conflicted queue (120_3) from the group (121) that was selected by the arbitration process. The process continues in step 232.

In step 224, when no work has been found in any of the conflicted queues (120_3) of the bidding groups (121), the get-work arbiter (122) next determines whether any of the bidding groups (121) have work in an admission queue (120_1). When the determination is negative, i.e., no work is found in the admission queue (120_1), the process continues in step 226; otherwise, the process continues in step 228.

In step 226, get-work arbiter (122) provides an indication that no work is available is to the work-slot (126_1). The work-slot (126_1) notifies software entity executing on the processor core (114_1) that no work is available. The process is finished until a new process starts in step 202.

In step 228, the get-work arbiter (122) arbitrates among only the admission queues (120_1) of the bidding groups (121) to select one group (121), from which work will be provided to the work-slot (126_1) and, eventually, to the software entity executing on one of the processor cores 114_1. The process continues in step 230.

In step 230, the SSO unit (116) retrieves work from the admission queue (120_1) of the group (121) that was selected by the arbitration process . The process continues in step 232.

In step 232, the SSO unit (116) determines whether the work comprises a tag. When the determination is negative, the processing continues in step 214; otherwise, the processing continues in step 236.

In step 236, the work-slots (126) comprising work compare work tags when the tags match and the tag-type is atomic; the process continues in step 238, otherwise, the process continues in step 240.

In step 238, because the work has an atomic tag-type, the work is conflicting with another work being executed, and cannot be immediately scheduled. Consequently, the tag-chain manager (124) adds the work to a tag-chain corresponding to the tag value when such a tag-chain exists, or establish a new tag-chain when tag-chain corresponding to the tag value does not exist. When the work is available for scheduling because all conflicted works ahead were executed, the SSO unit (116) moves the work to the conflicted queue (120_3). The process continues in step 202.

In step 240, the tag-chain manager (124) compares the work tag is against work tag in the conflicted queue (120_3) and when the tags match and the tag-type is atomic; the process continues in step 238, otherwise, the process continues in step 242.

In step 242, the tag-chain manager (124) compares the work tag is against work tag in the de-scheduled queue (120_2) and when the tags match and the tag-type is atomic; the process continues in step 238, otherwise, the process continues in step 214.

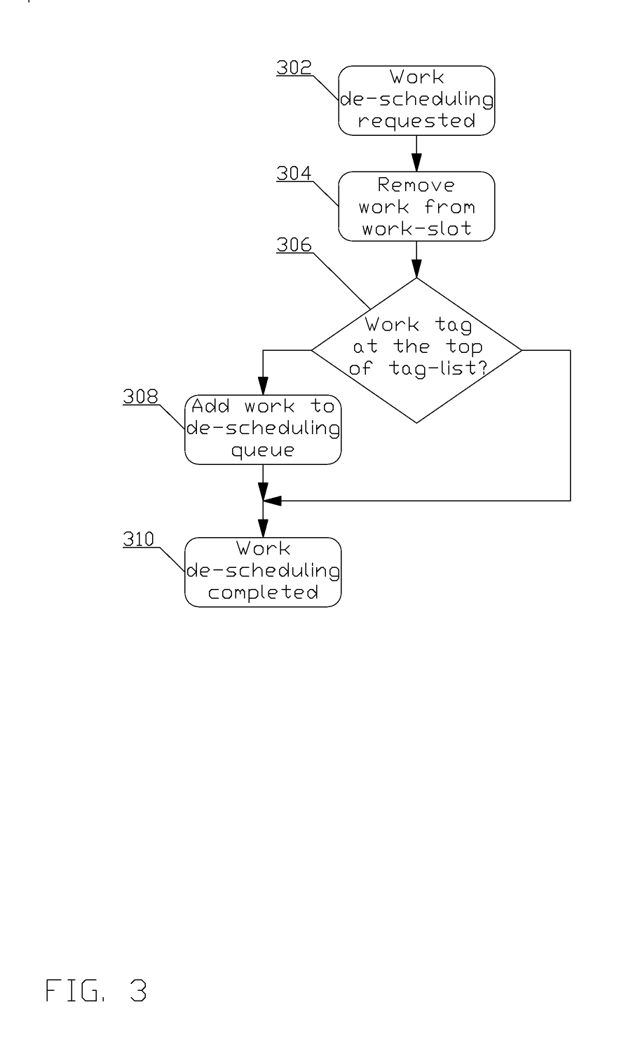

As disclosed supra, a software entity running on a processor core may de-schedule scheduled work. Reference is now made to FIG. 3, depicting a flow chart enabling a process of de-scheduling work in a network processor in accordance with an aspect of this disclosure. To clarify the relationship between certain elements of a conceptual structure and information flow among the elements of the structure enabling the process of pre-fetching work for processor cores in a network processor depicted in FIG. 1 in the FIG. 3 description, the references to structural elements of FIG. 1 are in parenthesis.

In step 302, a software entity executing on one of the processor cores (114), e.g., the processor core (114_1), decides to de-schedule work and requests the SSO unit (116) via an associated work-slot (126_1) to de-schedule the work. In an aspect the request comprises a store instruction to an I/O address inside the SSO unit 116. The process continues in step 304.

In step 304, the SSO unit (116) removes work from the work-slot (126_1). Since the work has been removed from the work-slot (126_1), the work will no longer cause work-slot tag conflicts as disclosed supra. The process continues in step 306.

In step 306, the tag-chain manager (124) determines whether the work entry is at the top of the tag-chain. When the determination is affirmative, the process continues in step 308; otherwise, the process continues in step 310.

In step 308, the tag-chain manager (124) adds the de-scheduled work to the top of the de-scheduled queue (120_2), thus making the work eligible for rescheduling at a later time.

In step 310, the de-scheduling is complete because the work related tag is at the top of the tag-chain; consequently, the de-scheduled work was not at the top of the tag-chain; therefore, the work needs to wait for work ahead in the tag-chain to complete.

As disclosed supra, work requested by a software entity running at a processor core and scheduled by the SSO unit is placed into a work-slot. When the software entity running at the processor core completes the work, the software entity requests a removal of the work from the work-slot. When another at least one work were waiting for completion of the work being currently executed, e.g., in a tag-chain, one of the at least one work is selected for processing.

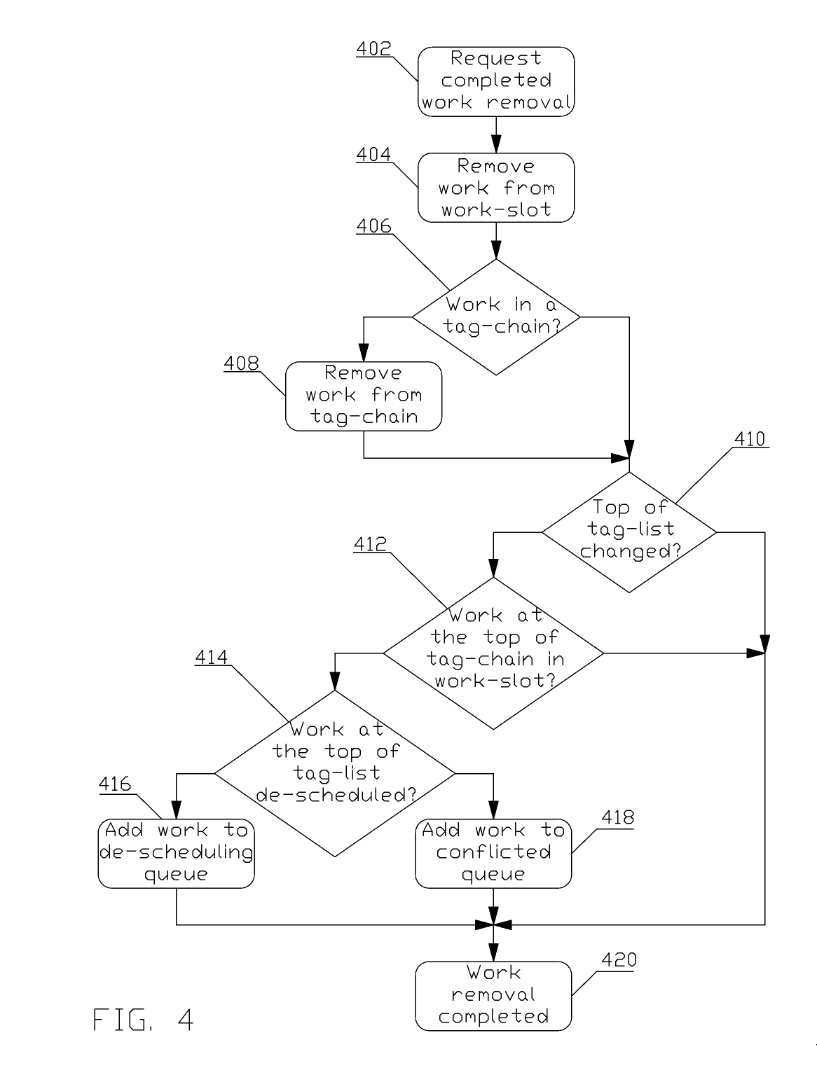

Reference is now made to FIG. 4, depicting a flow chart enabling the process of removal of work from the work-slot in a network processor in accordance with an aspect of this disclosure. To clarify the relationship between certain elements of a conceptual structure and information flow among the elements of the structure enabling the process of removal of the work from the work-slot in a network processor in a network processor depicted in FIG. 1 in the FIG. 4 description, the references to structural elements of FIG. 4 is in parenthesis.

In step 402, software entity running at a processor core (114), e.g., processor core (114_1) completes the work. The processor core (114_1) requests the SSO unit (116) via work-slot, e.g., work-slot (126_1) to remove the completed work. In an aspect the request comprises a store instruction to an I/O address inside the SSO unit (116). The process continues in step 404.

In step 404, the SSO unit (116) removes work from the work-slot (126_1). Since the work has been removed from the work-slot (126_1), the work will no longer cause work-slot tag conflicts as disclosed supra. The process continues in step 406.

In step 406, the SSO unit (116) determines whether the work has an entry in a tag-chain. When the determination is affirmative, the process continues in step 408; otherwise, the process continues in step 410.

In step 408, the SSO unit (116) removes the work from the tag-chain. The process continues in step 410.

In step 410, the tag-chain manager (124) determines whether the top of the tag-chain has changed. When the determination is negative, that means that either there was no work in the tag-chain, or the removed work was not at the top of the tag-chain; therefore, the work with an entry in the tag-chain waiting for completion of the work completion by the processor core (114_1) needs to wait for a work ahead in the tag-chain to complete. In either of these two cases, the process continues in step 420; otherwise, the process continues in step 412.

In step 412, the work-slot (126_1) determines whether the top of the tag-chain comprises a work that is already in a work-slot (126_1) because another processor core (114) requested the tag of the work-slot (126_1) be changed to match the tag of the completed work-slot's tag. In an aspect this change is requested by the work-slot (126_1) to be performed by an I/O write. When the determination is affirmative, that means that the work has already been scheduled and the process continues in step 420; otherwise, the process continues in step 414.

In step 414, the SSO unit (116) determines whether the top of the tag-chain comprises a work that had been de-scheduled. When the determination is positive, the process continues in step 416; otherwise, the process continues in step 418.

In step 416, the SSO unit (116) adds the work to the de-scheduling queue (120_2), because the work had been de-scheduled, but could not be re-scheduled due to tag conflicts. Since the conflict has now been resolved, the work is eligible for re-scheduling. The process continues in step 420.

In step 418, the SSO unit (116) adds the work to the conflicted queue (120_2), because the work was added to the tag-chain because the work could not be scheduled due to tag conflicts. Since the conflict has now been resolved, the work is eligible for re-scheduling. The process continues in step 420.

In step 420, the removal of the work is completed.

The various aspects of this disclosure are provided to enable a person having ordinary skill in the art to practice the present invention. Various modifications to these aspects will be readily apparent to persons of ordinary skill in the art, and the concepts disclosed therein may be applied to other aspects without departing from the spirit or scope of the invention. Thus, the present invention is not intended to be limited to the aspects shown herein but is to be accorded the widest scope consistent with the principles and novel features disclosed herein.

Therefore, by means of an example a person having ordinary skill in the art will understand, that the flow chart is not exhaustive because certain steps may be added or be unnecessary and/or may be carried out in parallel based on a particular implementation. By means of an example, unless otherwise specified the steps may be carried out in parallel or in sequence. Furthermore, the sequence of the steps may be re-arranged as long as the re-arrangement does not result in functional difference.

All structural and functional equivalents to the various illustrative logical blocks, modules, circuits, and algorithm steps described in connection with the various aspects described throughout this disclosure that are known or later come to be known to those of ordinary skill in the art are expressly incorporated herein by reference and are intended to be encompassed by the claims. Such illustrative logical blocks, modules, circuits, and algorithm steps may be implemented as electronic hardware, computer software, or combinations of both.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof

Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for processing conflicting work, comprising:
receiving a work request, the work request indicating one or more groups from a plurality of groups;
finding work by arbitrating among a plurality of queues of the one or more groups;
determining whether the found work conflicts with another work;
returning the found work when the determination is negative; and
adding the found work into a tag-chain when the determination is affirmative.

2. The method as claimed in claim 1, wherein the finding work by arbitrating among a plurality of queues of the one or more groups comprises:
determining whether at least one of the one or more groups has work in a de-scheduled queue; and
finding the work by arbitrating among the at least one group when the determination is affirmative.

3. The method as claimed in claim 2, further comprising:
determining whether at least one of the one or more groups have work in a conflicted queue when none of the one or more groups has work in the de-scheduled queue; and
finding the work by arbitrating among the at least one group when the determination is affirmative.

4. The method as claimed in claim 3, further comprising:
determining whether at least one of the one or more groups has work in an admission queue when none of the one or more groups has work in the conflicted queue; and
finding the work by arbitrating among the at least one groups when the determination is affirmative.

5. The method as claimed in claim 4, further comprising:
providing indication that no work is available when none of the one or more groups ha work in the admission queue.

6. The method as claimed in claim 1, wherein the determining whether the found work conflicts with another work comprises:
determining whether the found work was found in a de-scheduled queue; and
declaring the found work non-conflicting.

7. The method as claimed in claim 1, wherein the determining whether the found work conflicts with another work comprises:
determining whether the found work conflicts with another work when the found work was found in a conflicted queue or in an admission queue.

8. The method as claimed in claim 1, wherein the determining whether the found work conflicts with another work comprises:
determining whether the found work conflicts with a currently executed work.

9. The method as claimed in claim 1, wherein the determining whether the found work conflicts with another work comprises:
determining whether the found work conflicts with work in a conflicted queue.

10. The method as claimed in claim 1, wherein the determining whether the found work conflicts with another work comprises:
determining whether the found work conflicts with work in a de-scheduled queue.

11. The method as claimed in claim 1, further comprising:
re-scheduling the found work added into the tag-chain.

12. The method as claimed in claim 11, wherein the rescheduling the found work added into the tag-chain comprises:
ascertaining that execution of work ahead of the found work has finished;
determining whether the found work has been de-scheduled; and
moving the found work to a de-scheduled queue when the determining is affirmative.

13. The method as claimed in claim 12, further comprises:
moving the found work to a conflicted queue when the determining is negative.

14. An apparatus for processing conflicting work, comprising:
at least one work-slot configured to receive work request, the work request indicating one or more groups from a plurality of groups;
and a get-work arbiter configured to:
find work by arbitrating among a plurality of queues of the one or more groups;
determine whether the found work conflicts with another work; and
return the found work when the determination is negative; and
a tag-chain manager configured to add the found work into a tag-chain when the determination is affirmative.

15. The apparatus as claimed in claim 14, wherein the get-work arbiter finds a work by arbitrating among a plurality of queues of the one or more groups by being configured to:
determine whether at least one of the one or more groups has work in a de-scheduled queue; and
find the work by arbitrating among the at least one group when the determination is affirmative.

16. The apparatus as claimed in claim 15, wherein the get-work arbiter is further configured to:
determine whether at least one of the one or more groups has work in a conflicted queue when none of the one or more groups have work in the de-scheduled queue; and
find the work by arbitrating among the at least one group when the determination is affirmative.

17. The apparatus as claimed in claim 16, wherein the get-work arbiter is further configured to:
determine whether at least one of the one or more groups has work in an admission queue when none of the one or more groups has work in the conflicted queue; and
find the work by arbitrating among the at least one group when the determination is affirmative.

18. The apparatus as claimed in claim 17, wherein the get-work arbiter is further configured to:
provide indication that no work is available when none of the one or more groups has work in the admission queue.

19. The apparatus as claimed in claim 14, wherein the get-work arbiter determines whether the found work conflicts with another work by being configured to:
determine whether the found work was found in a de-scheduled queue; and
declare the found work non-conflicting when the determination is positive.

20. The apparatus as claimed in claim 14, wherein the get-work arbiter determines whether the found work conflicts with another work by being configured to:
determine whether the found work conflicts with another work when the found work was found in a conflicted queue or in an admission queue.

21. The apparatus as claimed in claim 14, wherein the get-work arbiter determines whether the found work conflicts with another work by being configured to:
determine whether the found work conflicts with a currently executed work.

22. The apparatus as claimed in claim 14, wherein the get-work arbiter determines whether the found work conflicts with another work by being configured to:
determine whether the found work conflicts with work in a conflicted queue.

23. The apparatus as claimed in claim 14, wherein the get-work arbiter determines whether the found work conflicts with another work by being configured to:
determine whether the found work conflicts with work in a de-scheduled queue.

24. The apparatus as claimed in claim 14, wherein the schedule, synchronize, and order unit is further configured to:
re-schedule the found work added into the tag-chain.

25. The apparatus as claimed in claim 24, wherein the schedule, synchronize, and order unit reschedules the found work added into the tag-chain by being configured to:
ascertain that execution of work ahead of the found work has finished; and
determine whether the found work has been de-scheduled; and
wherein the tag-chain manager is configured to move the found work to a de-scheduled queue when the determination is affirmative.

26. The apparatus as claimed in claim 25, the tag-chain manager is further configure to:
move the found work to a conflicted queue when the determination is negative.
